(19) United States
(12) Patent Application Publication
(10) Pub. No.: US 2026/0116737 A1
(43) Pub. Date: Apr. 30, 2026

(54) SELF CALIBRATING FLOW RATE AND TANK LEVEL MEASUREMENT SYSTEM

(71) Applicant: Sirius Instrumentation and Controls Inc., Edmonton (CA)

(72) Inventors: Colin Bussiere, Ardrossan (CA); Curtis Jabusch, Edmonton (CA)

(21) Appl. No.: 19/364,766

(22) Filed: Oct. 21, 2025

Related U.S. Application Data
(60) Provisional application No. 63/712,791, filed on Oct. 28, 2024.

(51) Int. Cl. B67D 7/16; B67D 7/08; G01F 1/34; G01F 25/10

(52) U.S. Cl. CPC B67D 7/163; B67D 7/085; G01F 1/34; G01F 25/10

(57) ABSTRACT

A tank level and flow rate measurement system and method is described for use with a chemical injection pump and a chemical storage tank. The system includes a device comprising a measurement column of known volume, an upper pressure sensor and a lower pressure sensor, a valve for controlling fluid filling of the device from the storage tank, and a fluid outlet connected to the pump, a vent tube which extends above the measurement column and the upper pressure sensor; and a controller operably connected to the upper pressure sensor and the lower sensor, configured to receive pressure measurements and determine a base state where both upper and lower sensors read atmospheric pressure only and a measurement state where the upper sensor reads atmospheric pressure only and the lower sensor reads a pressure based on fluid level in the measurement column.

### FIELD OF THE INVENTION

The present invention generally relates to a method and system for self-calibrating a flow rate and tank level measurement system.

### BACKGROUND

Chemical injection pumps (CIPs) are used throughout the oil and gas industry. Their primary purpose is to inject relatively small amounts of chemicals into process streams to enable or enhance the production and processing of petroleum products. CIPs are used to inject a wide range of chemicals, such as demulsifiers, solvents, de-salting agents, corrosion inhibitors, biocides, clarifiers, scale inhibitors, hydrate inhibitors, paraffin dewaxers, surfactants, oxygen scavengers, or hydrogen sulphide scavengers. One common use is to inject methanol into a natural gas process to reduce or eliminate hydrates, which can cause blockage in a pipeline upon freezing.

The chemical being injected is conventionally stored onsite in a larger vessel. Flow sensors and level sensors are used to determine flow rates and tank levels. These sensors require periodic calibration to ensure accurate measurements.

Typically, the chemicals are injected at a precise rate, which can be quite low. A positive displacement pump is conventionally used, such as a reciprocating or a solenoid design, operating from 1 to about 1000 pulses per minute. Due to many factors such as the use of oversized lines, pulsations, wide range of flow or pressure, it is difficult for a device to quickly, accurately and repeatably measure flow.

It is known to have a device which measures the change in fluid height in the storage tank and calculates for volume between two points over a period of time, but these are not very accurate because external disturbances such as changes in pressure, temperature, density, gravitational forces are not accounted for.

There remains a need in the art for a self-calibrating flow rate and tank level measurement system.

### SUMMARY OF THE INVENTION

The present disclosure relates to a self-calibrating flow rate and tank level measurement system. In one aspect, disclosed is a system which comprises:
(a) a device comprising a measurement column of known volume, an upper pressure sensor and a lower pressure sensor, a valve for controlling fluid filling of the device from the storage tank, and a fluid outlet connected to the pump;
(b) a vent tube which extends above the measurement column and the upper pressure sensor; and
(c) a controller operably connected to the upper pressure sensor and the lower sensor, configured to receive pressure measurements and determine a base state where both upper and lower sensors read atmospheric pressure only and a measurement state where the upper sensor reads atmospheric pressure only and the lower sensor reads a pressure based on fluid level in the measurement column.

In another aspect, disclosed is a method of calibrating a tank level and flow rate measurement system which comprises a measurement column of known volume, an upper pressure sensor above the measurement column and a lower pressure sensor below the measurement column, comprising the step of zeroing both upper and lower pressure sensor readings when both the upper and lower sensors read atmospheric pressure only, determining flow rate by measuring a rate of pressure differential change during a period of time when the upper sensor reads atmospheric pressure only and the lower sensor reads a pressure based on fluid level in the measurement column.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a schematic view of a chemical injection system comprising an embodiment of a fluid level measurement device, a chemical storage tank and a chemical injection pump.

FIG. 2 shows an isometric view of the measurement device of FIG. 1.

FIG. 3 shows a plan view of the measurement device of FIG. 1.

FIG. 4 shows a vertical cross-section view of the measurement device of FIG. 1, with markings for reference heights and inside diameter of the measurement column.

FIG. 5 shows a graph of pressure readings from lower and upper sensor, after both sensors have been calibrated to zero at atmospheric pressure.

FIG. 6 shows a graph, derived from the data represented in FIG. 5, showing the differential pressure between the lower and upper sensors as the measurement device is filled with fluid.

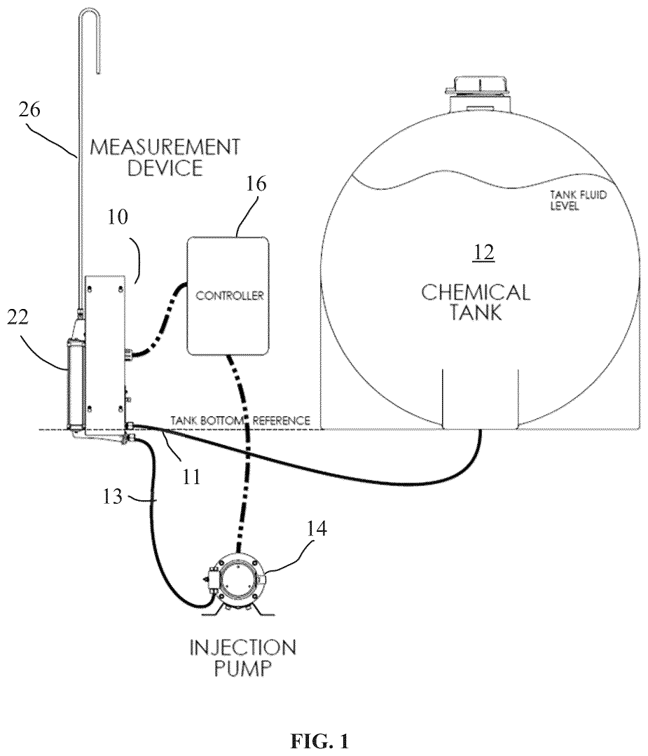

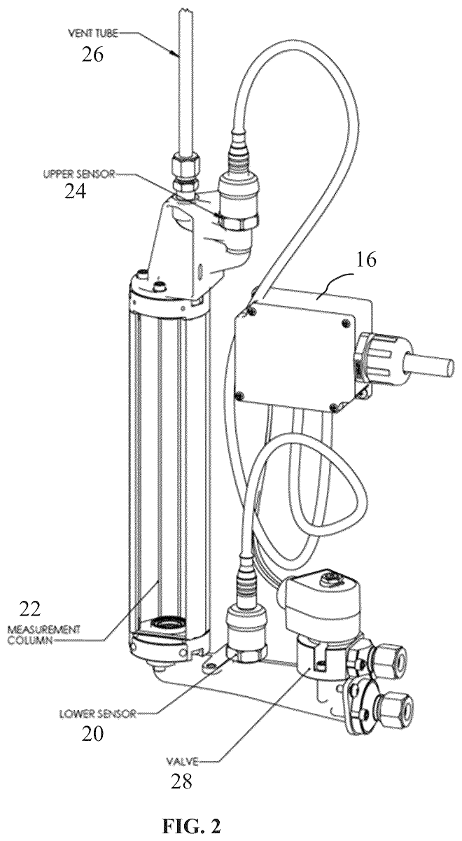

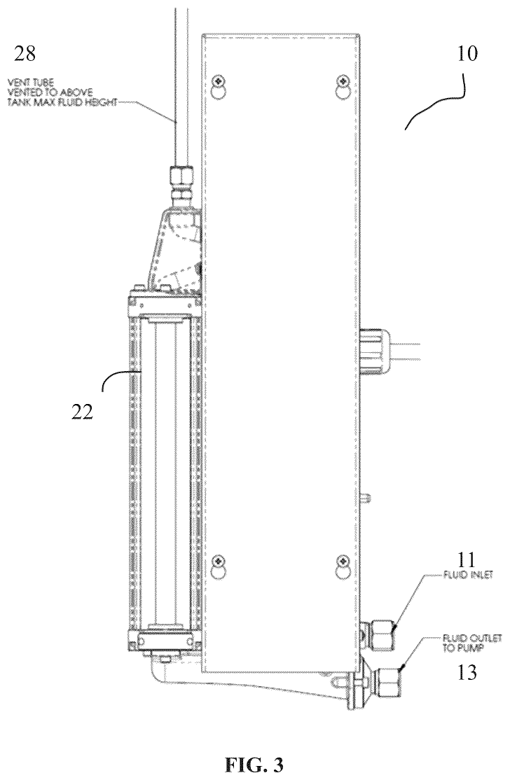

### DETAILED DESCRIPTION

The present invention now will be described more fully hereinafter with reference to the accompanying drawings, in which some, but not all embodiments of the invention are exemplified. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

In one aspect, described is a tank level and flow rate measurement device 10, which together with a controller, can be used to control delivery of a fluid chemical by means of a chemical injection pump. The device 10 has a fluid inlet 11 is connected to the outflow of a chemical storage tank 12, and a fluid outlet 13 connected to the intake of an injection pump 14, or other means of delivering a flow of chemical into a process (not shown).

A controller 16 is operably connected to the device 10 to receive measurements and control movement of fluid through the device by controlling one or more valves. The controller 16 is also operably connected to the pump 14 to at least control operation of the pump. The pump 14 itself may include various sensors which may be used to provide data to the controller 16, such as pump operating parameters (pump rate, flow rate, pressure, temperature etc.).

In some examples, controller 16 is operable to receive various data and transmits control instructions, as disclosed herein, in real time or near real time. This allows for real time, or near real time, operation of disclosed systems.

“Operably connected” refers to an arrangement in which two or more components are linked, directly or indirectly, such that operation of one influences, enables, or controls operation of another. The coupling may include any combination of mechanical, electrical, or optical interfaces, and may involve intermediary circuitry, processors, or communication modules. The coupled elements may exchange data or control signals through wired or wireless communication.

The controller 16 comprises one or more processors or electronic devices that is/are capable of reading and executing instructions stored in a memory to perform operations on data, which may be stored on a memory or provided in a data signal. The term “processor” includes a plurality of physically discrete, operably connected devices despite use of the term in the singular. Non-limiting examples of processors include devices referred to as programmable logic controller (PLC), microprocessors, microcontrollers, central processing units (CPU), and digital signal processors. The controller may also access memory which comprises non-transitory tangible computer-readable medium for storing information in a format readable by a processor, and/or instructions readable by a processor to implement an algorithm. The term “memory” includes a plurality of physically discrete, operably connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages. It will be understood herein that reference to the controller 16 performing or executing an action implies that the processor is executing one or more instructions stored on the memory.

The device 10 comprises a lower pressure sensor 20, a measurement column 22 which is preferably transparent so that the fluid inside the column may be seen, an upper pressure sensor 24, and a vent tube 26 which extends upwardly from the measurement column 22 and the upper sensor 24. Each of the lower and upper sensors 20, 24 may be operably connected to the controller 16 to transmit measured pressure values thereto. A valve 28 controls fluid flow into the device 10 from the storage tank 12 and includes an actuator controlled by the controller 16. In preferred embodiments, the device is positioned such that the lower sensor 20 is level with the bottom of the storage tank 20. Thus, fluid flow into the device 10 may be gravity driven upon opening of the valve 28. The injection pump 14 is preferably positioned lower than the lowest point in the device 10, such that fluid will feed the pump by gravity flow. It is not preferred to use a pump that creates intake suction as that can affect the pressure readings from the measurement device.

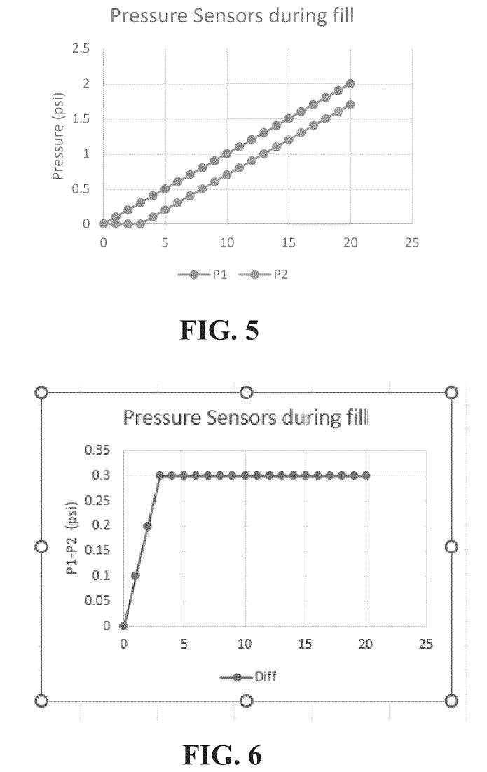

In operation, the device 10 is emptied of fluid to a point below the lower sensor 20, such as by closing valve 28 and draining the device. At this point, both lower and upper sensors 20, 24 read atmospheric pressure only, and may then be calibrated to zero. The device is then filled with fluid from the chemical tank 12 such that the fluid fills the measurement column and rises up the vent tube 26 to a level which matches the level of the fluid in the storage tank 12. In one embodiment, the vent tube 26 is open to the atmosphere. As the fluid fills the measurement column before reaching the upper sensor 24, the lower sensor 20 will read an increasing amount of pressure while the upper sensor remains at zero, as can be seen in the first phase of the pressure plots shown in FIG. 5. This pressure differential between the lower sensor 20 and the upper sensor 24 will increase until the fluid reaches the upper sensor 24, after which further filling will not increase the differential pressure, as may be seen in FIG. 6.

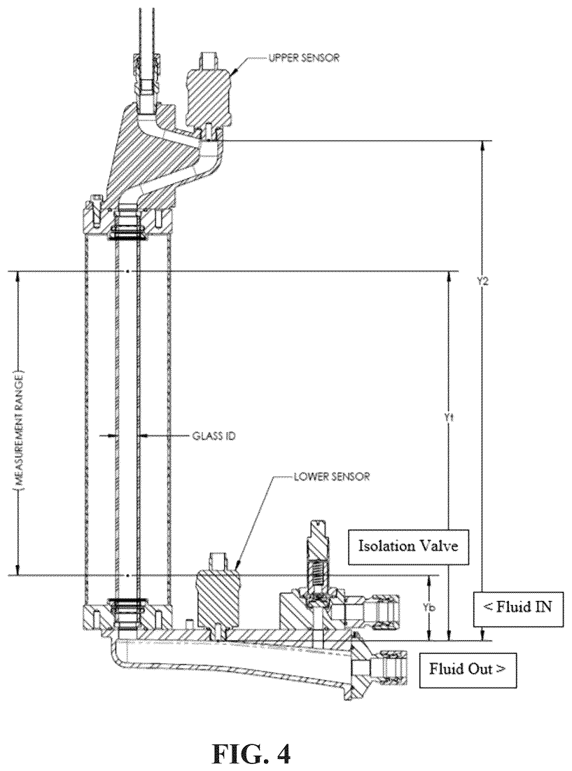

The differential pressure between the lower and upper sensor allows calculation of the fluid density in the measurement column when the measurement column is full, as the volume of fluid in the filled column—as between the lower and upper sensors 20, 24—is known or can be empirically measured. This filled volume is a function of height Y2 (the vertical distance between the upper sensor 24 and the lower sensor 20) shown in FIG. 4, and the inside diameter of the measurement column and the fluid contained in the passageways immediately above and below the measurement column. In some examples, various of the aforementioned values are stored in a memory of the controller 16 to allow the controller 16 to automatically determine the fluid density, as required.

After the measurement column 22 and vent tube 26 is filled with a fluid, the fluid level in the measurement device and in the chemical storage tank will equalize. Thus, the level of fluid in the tank may be determined visually in the measurement device. At this point, the differential pressure is recorded (e.g., by controller 16 based on the pressure value data received from sensors 20, 24), and chemical injection may proceed at the desired flow rate. The differential pressure will remain constant until the fluid level drops below the upper sensor 24, at which point the upper sensor 24 should read zero, and the lower sensor 20 pressure will decrease at a rate proportional to the flow rate. Thus, the flow rate may be calculated (e.g., by controller 16) with reference to the rate of decrease of the pressure of the lower sensor 20 when the upper sensor reads zero. In some examples, controller 16 monitors the pressure reported by the upper sensor 20. When the upper sensor 20 reports atmospheric pressure (e.g., a zero value), the controller 16 is triggered to monitor the pressure reported by the lower sensor 20 to determine the change in reported pressure as between at least two given time instances (i.e., to determine the corresponding flow rate).

Preferably, the fluid flow rate measurement zone occurs in the zone Yt shown in FIG. 4. Thus, the flow rate may be accurately determined by correlating the decrease in pressure measured by the lower sensor over time.

If the measured flow rate varies from a desired flow rate, the controller 16 can adjust the pump speed, or on-time of the pump, in a closed loop control system (e.g., with a PID controller), in order to maintain the desired flow rate, ensuring dosing accuracy of the chemical injection process.

In one embodiment, the measured fluid density may be compared (e.g., by controller 16) against fluid density readings at a later time, which can identify changes in fluid density related to fluid health. For example, if a volatile component in the fluid is prone to evaporation, or separation of blended components occurs, the nature of the injected fluid may change and a change in fluid density may occur. Early detection of an unwanted fluid density change is advantageous.

In one embodiment, the controller can be configured to detect a “run-dry” scenario, to prevent a pump from running dry. The pressure differential may be monitored by controller 16 such that if a pressure differential indicative of fluid filling the measurement column does not occur when predicted or scheduled, then the controller can turn off the pump until the situation can be rectified. Optionally, the controller 16 may be linked to a visible or audible alarm, and/or may comprise a communication module configured to send an alert or message by email or SMS, or any suitable messaging service. In other cases, controller 16 is coupled to any other suitable output interface to generate any other desired output.

In preferred embodiments, the controller may refer to stored values which are indicative of normal or desired operation. If any operating parameter of any sensor or pump is determined to fall outside of a normal or desired range, then the controller may issue an alert or notification, or any other output, such as by text message if the controller is operably connected to a communication module.

If no pressure differential is detected, then it may be that the sensors have drifted and may require recalibration. The valve may be opened (e.g., manually or automatically by controller 16) to ensure the pump is pumping fluid, until a baseline calibration can be performed. As described above, once it is known that the fluid level has dropped below the lower sensor, the valve may be closed (e.g., manually or automatically by controller 16) and both the lower and upper sensors 20, 24 can be calibrated to zero, as they both should be reading atmospheric pressure only.

In preferred embodiments, the measured differential pressure can be used to at least partially compensate for pump pulsations which could affect the quality of the fluid column measurement. If the fluid level has risen above the upper sensor 24 into the vent tube 26, any pulses caused by pump operation will affect both the lower and upper sensors 20, 24, and thus the controller 16 may be configured to cancel any such pressure pulses.

In preferred embodiments, the differential pressure measurement and a fast-acting valve allows for a shorter measurement column, while maintaining accurate measurement in real-time.

In preferred embodiments, the pressure reading from the upper sensor 24 may be monitored for significant deviations from atmospheric pressure, which could be indicative of a system obstruction, such as a blockage in the vent tube. In conditions where the upper sensor 24 should be reading atmospheric pressure, such as when the fluid level is pumped down between the upper and lower sensors or below the bottom sensor, if there is any material variation from atmospheric pressure, it would be indicative of a plugged vent line. The system may be configured to issue a notification or alert, or other output.

### Interpretation.

The forgoing description supplies specific details in order to provide a thorough understanding. Nevertheless, the skilled artisan would understand that the apparatuses, systems, and associated methods of using the apparatuses and systems can be implemented and used without employing these specific details. Indeed, the apparatuses, systems, and associated methods can be placed into practice by modifying the illustrated apparatus and associated methods and can be used in conjunction with any other apparatus and techniques conventionally used in the industry.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular claim, feature, structure, or characteristic, but not every embodiment necessarily includes that claim, feature, structure, or characteristic. Moreover, such phrases may, but do not necessarily, refer to the same embodiment referred to in other portions of the specification. Further, when a particular claim, feature, structure, or characteristic is described in connection with an embodiment, it is within the knowledge of one skilled in the art to affect or connect such module, claim, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. A tank level and flow rate measurement system for use with a chemical injection pump and a chemical storage tank, comprising:
a. a device comprising a measurement column of known volume, an upper pressure sensor and a lower pressure sensor, a valve for controlling fluid filling of the device from the storage tank, and a fluid outlet connected to the pump;
b. a vent tube which extends above the measurement column and the upper pressure sensor;
c. a controller operably connected to the upper pressure sensor and the lower sensor, configured to receive pressure measurements and determine a base state where both upper and lower sensors read atmospheric pressure only and a measurement state where the upper sensor reads atmospheric pressure only and the lower sensor reads a pressure based on fluid level in the measurement column.

2. The system of claim 1 wherein the controller is configured to determine flow rate by measuring the rate of pressure decline in the measurement state.

3. The system of claim 2 wherein the controller is operably connected to:
a. the valve to control filling of the device with fluid; and/or
b. the pump to control operation of the pump and/or to receive pump data.

4. The system of claim 3 wherein the controller is configured to control pump rate to maintain a desired flow rate.

5. The system of claim 1 wherein the controller is configured to determine fluid density by determining the pressure differential between the upper sensor and the lower sensor when the measurement column is full of fluid up to the level of the upper sensor.

6. The system of claim 5 wherein the controller is configured to compare fluid density determined at different times, and to issue an alert if the fluid density substantially changes.

7. The system of claim 4, wherein the controller is configured to issue an alert if any operating parameter is not within an expected range.

8. A method of calibrating a tank level and flow rate measurement system which comprises a measurement column of known volume, an upper pressure sensor above the measurement column and a lower pressure sensor below the measurement column, comprising the step of zeroing both upper and lower pressure sensor readings when both the upper and lower sensors read atmospheric pressure only.

9. The method of claim 8, further comprising a step of determining flow rate by measuring a rate of pressure differential change during a period of time when the upper sensor reads atmospheric pressure only and the lower sensor reads a pressure based on fluid level in the measurement column.
